(19) United States
(12) Patent Application Publication
(10) Pub. No.: US 2008/0068834 A1
(43) Pub. Date: Mar. 20, 2008

(54) Lighting fixtures and lighting mounts

(75) Inventors: J. Vern Cunningham, Aurora (CA); Kevin Campbell, Woodbridge (CA)

Correspondence Address: Ralph A. Dowell of DOWELL & DOWELL P.C., 2111 Eisenhower Ave, Suite 406, Alexandria, VA, 22314, US

(73) Assignee: Cube Investments Limited, Aurora (CA)

(21) Appl. No.: 11/902,134

(22) Filed: Sep. 19, 2007

Related U.S. Application Data
(60) Provisional application No. 60/845,500, filed on Sep. 19, 2006.
(60) Provisional application No. 60/907,892, filed on Apr. 20, 2007.

(51) Int. Cl. F21L 4/00

(52) U.S. Cl. 362/191

(57) ABSTRACT

A lighting mount for use with battery and lighting source. Lighting mount having cavity to retain lighting source, battery holder to receive battery; mounting surface; and opening from cavity through which light from lighting source projects. Opening opens away from mounting surface and battery holder, and battery and cavity are on one side of lighting mount away from mounting surface. Cavity retains lighting source such that illumination axis can be directed at oblique angle away from mounting surface. Cavity comprises track for retaining lighting source. Battery holder comprises U-shaped channel. Lighting fixture has lighting mount and lighting source and electrical connections from battery holder to lighting source. Elongate body having lighting source holder section and battery holder section can be pivotally connected to a mounting base to allow for insertion of batteries and selection of angle between mounting surface and lighting source.

This application claims priority from, and is entitled to the benefit of the filing date of, U.S. patent application No. 60/845,500 entitled LIGHTING FIXTURE AND LIGHTING MOUNT filed 19 Sep. 2006; and U.S. patent application No. 60/907,892 entitled LIGHTING FIXTURES AND LIGHTING MOUNTS filed 20 Apr. 2007. The content of each of the above applications is hereby incorporated by reference into the detailed description hereof.

### FIELD OF THE INVENTION

The invention relates to lighting fixtures and lighting mounts. In particular, the invention relates to lighting fixtures powered by batteries and lighting mounts for battery powered lighting fixtures.

### BACKGROUND

There are many prior lighting fixture designs for battery operation. Further alternative designs are desirable.

### SUMMARY

In a first aspect the invention provides a lighting mount for use with at least one battery and a lighting source. The lighting mount includes an elongate battery holder section having a longitudinal dimension, the battery holder section adapted to retain the at least one battery, an elongate lighting source holder section having a longitudinal dimension, the lighting source holder section adapted to retain the lighting source, and a planar mounting surface. The battery holder section includes a channel wall defining a lineal channel having a longitudinal dimension substantially parallel to the battery holder section longitudinal dimension, the channel wall adapted to retain laterally the at least one battery in the channel. The lighting source holder section includes an elongate cavity having a longitudinal dimension substantially parallel to the lighting source holder section longitudinal dimension. The battery holder section and lighting source holder section are contiguous with one another along their respective longitudinal dimensions. The cavity is defined at least in part by a cavity wall and the cavity wall has at least one cavity opening from the cavity. The battery holder section and the lighting source holder section are on one side of the mounting surface. The at least cavity opening opens away from the mounting surface and the battery holder section. The at least one cavity opening opens such that light from the lighting source projects away from the mounting surface and the battery holder section.

The lighting mount may further include a mounting base. The mounting surface may be part of the mounting base. The lighting holder source section may be pivotally connected to the mounting base such that the openings can be pivoted to a desired angle with respect to the mounting surface.

The battery holder section and the lighting source holder section may together form an elongate body. The elongate body may be pivoted such that the channel is accessible for manual insertion of batteries into the channel.

The mounting base may include a pair of opposable mounting angles. Each angle may have a planar surface forming part of the mounting surface, a mounting flange extending away from the mounting surface, and a pivot pin extending away from the flange, the mounting angles being opposable such that the respective pivot pins are aligned with one another and aligned substantially parallel to the respective longitudinal dimension of the lighting source holder section and the battery holder section.

The lighting source holder section may be adapted to retain the at least one lighting source such that an illumination axis of the lighting source is directed at an oblique angle away from the mounting surface. The lighting source holder section may include two opposing longitudinally divided lighting source holder portions such that the cavity is accessible when the lighting source holder portions are separate from one another.

The mounting base may be an integral unit comprising the mounting surface, two opposing flanges extending away from the mounting surface, and a pair of pivot pins, one pivot pin extending away from each flange toward the other pivot pin such that the pivot pins are aligned with one another. The lighting source holder section may include opposing pivot apertures at either end of the lighting source holder section to receive the pivot pins.

The lighting source holder section may include two opposing longitudinally divided lighting source holder portions such that the cavity is accessible when the lighting source holder portions are separate from one another, and each lighting source holder section defines a portion of the opposing pivot apertures such that the pivot apertures are wholly defined when the lighting source holder portions are combined.

The mounting base may be resiliently flexible to permit expansion of the mounting base and snap fitting of the pivot pins into the pivot apertures.

The lighting source holder section may be adapted to retain the at least one lighting source such that an illumination axis of the lighting source is directed at an oblique angle away from the mounting surface.

In a second aspect the invention provides a lighting fixture including the lighting mount of the first aspect, the lighting source and electrical connections from the battery holder section to the lighting source.

The lighting source may include at least one LED. The lighting source may include plurality of LEDs. The lighting source may further include an elongate substrate along which the LEDs are linearly spaced. The elongate substrate may be an elongate printed circuit board. The lighting source may be a strip lighting source. The LEDs may be surface mount LEDs. The LEDs may be standard through-hole LEDs.

In a third aspect the invention provides a kit including the lighting mount with base of the first aspect, the lighting source and electrical connections from the battery holder section to the lighting source. The mounting base is separate from and connectable to the elongate body.

In a fourth aspect the invention provides a lighting mount for use with at least one battery and a lighting source. The lighting source is a strip lighting source with substantially parallel opposing first and second longitudinal edges. The lighting mount includes an elongate body having a longitudinal dimension. The body includes a battery holder section adapted to hold the at least one battery and a lighting source holder section adapted to hold the light source. The battery holder section includes a channel wall defining a lineal channel having a longitudinal dimension substantially parallel to the body longitudinal dimension. The channel wall is adapted to retain laterally the at least one battery in the channel. The lighting source holder section includes a cavity wall defining an elongate lineal cavity having a longitudinal dimension substantially parallel to the body longitudinal dimension. The cavity wall is adapted to retain laterally the lighting source in the cavity. The battery holder section and lighting source holder section are contiguous with one another along the longitudinal dimension of the body. The cavity wall has at least one cavity opening from the cavity through which light from the light source can project. The at least one cavity opening opens such that light from the lighting source projects from the cavity away from the battery holder section.

The channel wall may have a longitudinal channel aperture through which the channel wall is adapted to receive the at least one battery in the channel. The channel aperture may open away from the lighting source holder section.

The lighting source holder section may include a lineal track extending longitudinally substantially parallel to the longitudinal dimension of the body. The track may be adapted to retain laterally, and to slidably receive, the lighting source along the opposing longitudinal edges of the lighting source.

The lighting mount may be a single piece of material.

The body may have a uniform profile normal to its longitudinal dimension from a first end of the lighting mount to an opposing second end of the lighting mount, and the lineal cavity may extend from the first end to the second end.

The lighting mount may have a first end and a longitudinally opposing second end, and the channel may extend from the first end of the lighting mount to the second end of the lighting mount.

The at least one battery may be cylindrical. The channel may be U-shaped. A bottom of the U-shaped channel may conform to an arcuate surface of the at least one battery. A top of the U-shaped channel may be a longitudinal aperture in the channel wall adapted to receive into the channel the cylindrical at least one battery through the longitudinal aperture in the channel wall.

The cavity wall may have a first cavity wall portion extending from a second edge of the channel wall about a portion of the cavity to the at least one opening and a second cavity wall portion extending from the battery holder section at a line between the first edge and second edge of the channel wall. The second cavity wall may extend about another portion of the cavity to the at least one opening. The first cavity wall portion and second cavity wall portion may each contain opposing grooves that together form the track for retaining the at least one lighting source.

Opposing first and second linear bosses may extend into the channel from the first and second edges respectively. The channel edges may extend beyond a centreline of the battery.

The lighting mount may include a planar mounting surface. The battery holder section and lighting source holder section may be on one side of the mounting surface. The opening may open away from the mounting surface. The mounting surface may be on a mounting tab extending linearly from a first edge of the channel.

The lighting source holder section may be adapted to retain the at least one lighting source such that an illumination axis of the lighting source is directed at an oblique angle away from the mounting surface.

In a fifth aspect the invention provides a lighting fixture including the lighting mount of the first aspect, the lighting source, and electrical connections from the battery holder to the lighting source.

The lighting source may include a plurality of LEDs. The lighting source may include an elongate substrate along which the LEDs are linearly spaced. The elongate substrate may be an elongate printed circuit board. The LEDs may be surface mount LEDs.

The lighting fixture may include a first end cap enclosing a first end of the lighting mount and a second end cap enclosing an opposing second end of the lighting mount. Each end cap may have a flange extending outwardly away from the lighting mount parallel to the longitudinal dimension of the lighting mount. The flanges may include a planar mounting surface. The battery holder section and the lighting source holder section may be on one side of the mounting surface. The opening may open such that light from the lighting source projects from the cavity away from the mounting surface.

Other aspects of the invention will be evident from the detailed description, claims, and drawings herein.

### BRIEF DESCRIPTION OF THE DRAWINGS

For a better understanding of the present invention and to show more clearly how it may be carried into effect, reference will now be made, by way of example, to the accompanying drawings that show preferred embodiments of the present invention and in which:

FIG. 1 is a perspective view from above and in front of a lighting fixture in accordance with an embodiment of an aspect of the present invention;

FIG. 2 is an exploded perspective view from above, in front and to one side of the lighting fixture of FIG. 1;

FIG. 3 is an end view of the lighting fixture of FIG. 1;

FIG. 4 is a view of the lighting fixture of FIG. 1 with an end cap removed;

FIG. 5 is a front view of the lighting fixture of FIG. 1;

FIG. 6 is a top view of the lighting fixture of FIG. 1;

FIG. 7 is a rear view of the lighting fixture of FIG. 1;

FIG. 8 is a perspective view from the rear, above and to one side of the lighting fixture of FIG. 1 with double-sided tape;

FIG. 9 is the perspective view of FIG. 8 but with mounting screws;

FIG. 10 is a perspective view of the lighting fixture of FIG. 1 installed within a closet above a closet door with the closet door open;

FIG. 11 is a perspective view of a lighting fixture in accordance with an alternate embodiment of an aspect of the present invention;

FIG. 12 is a perspective view of the lighting fixture of claim 11 in an alternative pivoted position;

FIG. 13 is an exploded perspective view of the lighting fixture of FIG. 11;

FIG. 14 is an end view of an elongate body of the lighting fixture of FIG. 11;

FIG. 15 is a lateral cross-section of an elongate body of the lighting fixture of FIG. 11 along a line A-A′ from FIG. 11;

FIG. 16 is a perspective view of a battery holder section and lighting source holder section portion of the lighting fixture of FIG. 11 from a lighting source holder section portion perspective;

FIG. 17 is a perspective view of the battery holder section and lighting source holder section portion of FIG. 16 from a battery holder section perspective;

FIG. 18 is an interior perspective view of a further lighting source holder section portion of the lighting fixture of FIG. 11; and

FIG. 19 is a lateral cross-section of an elongate body of the lighting fixture of FIG. 11 along the lines B-B′ of FIG. 11.

### DETAILED DESCRIPTION

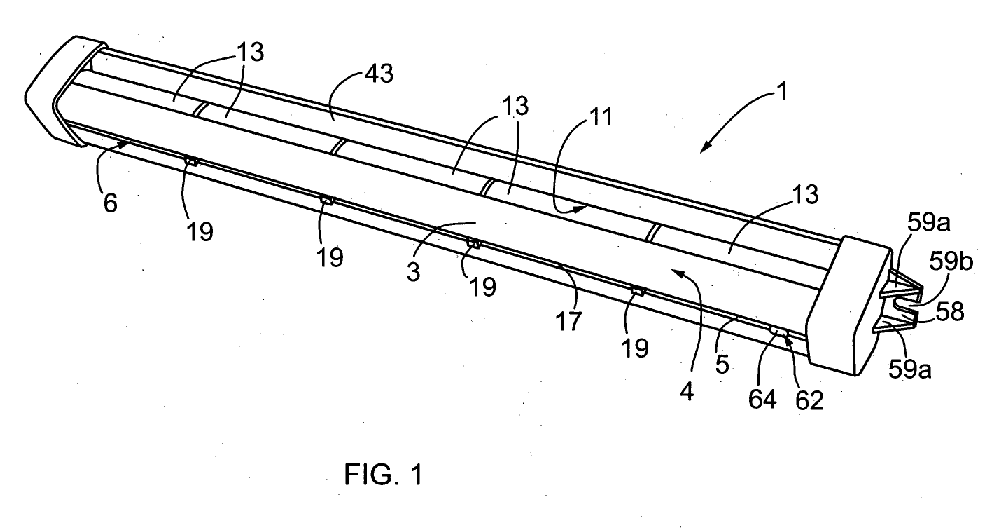

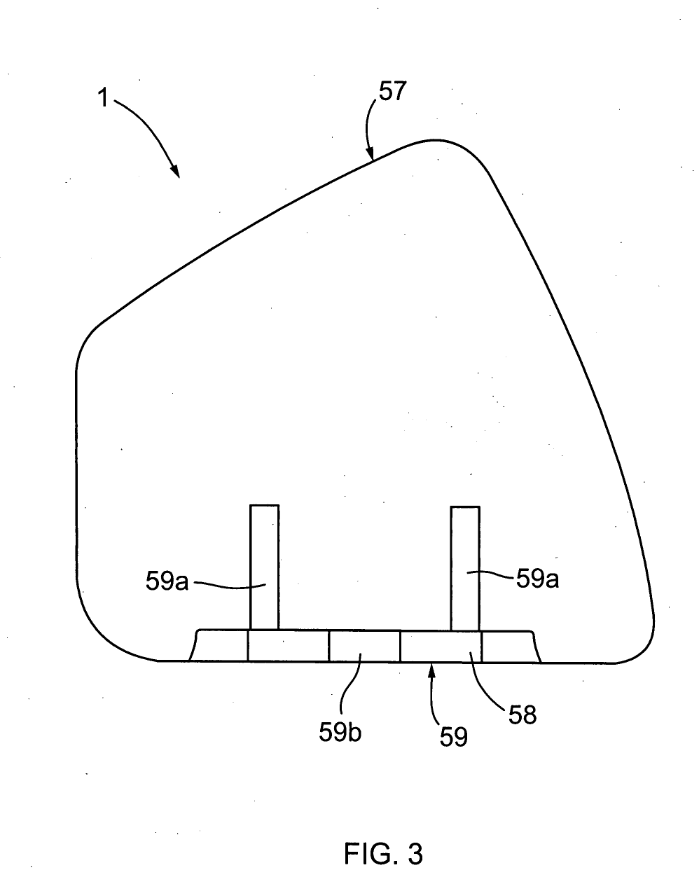

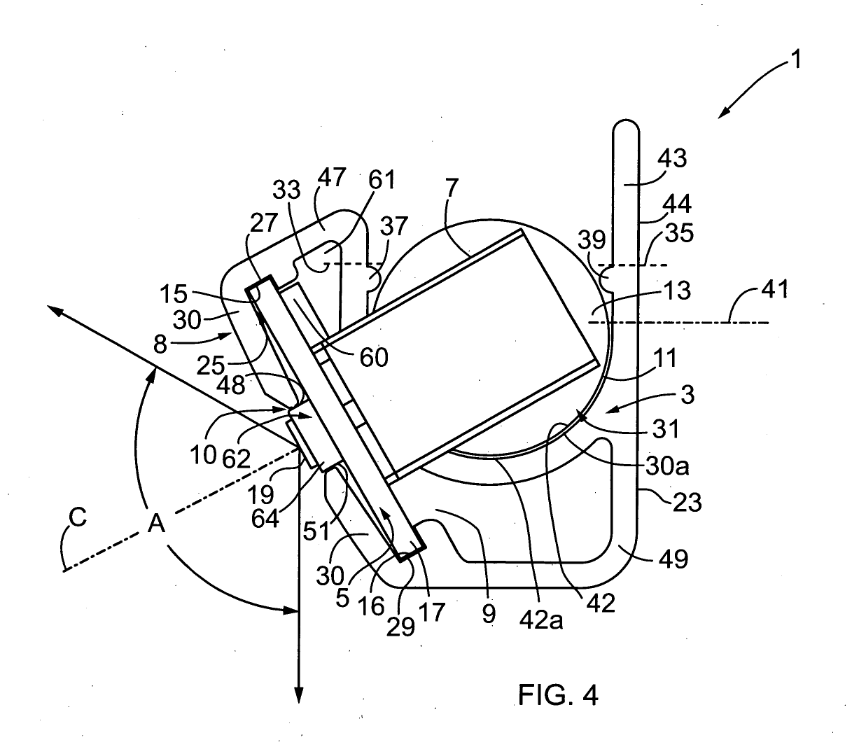

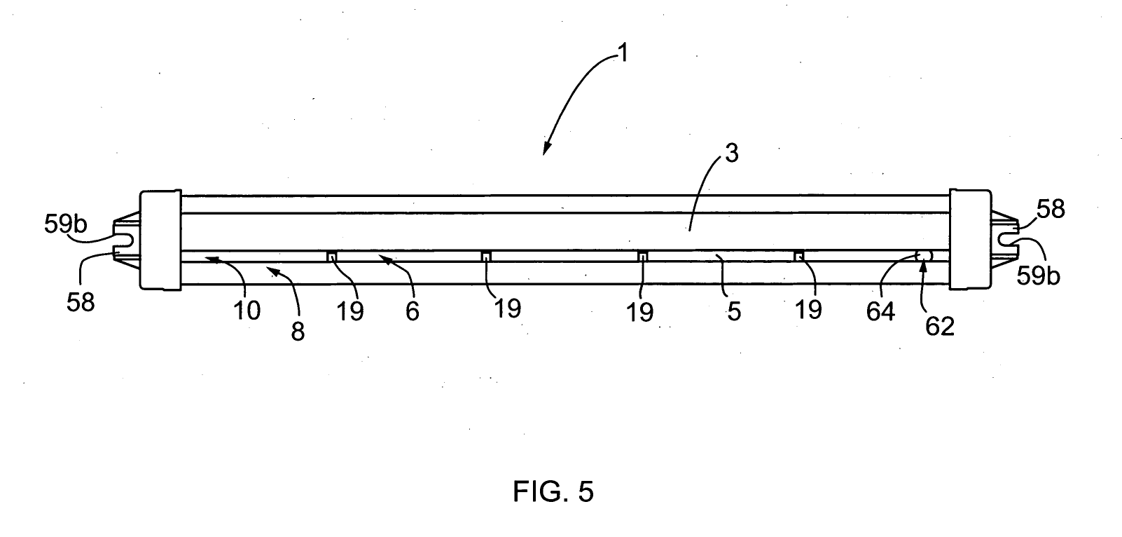

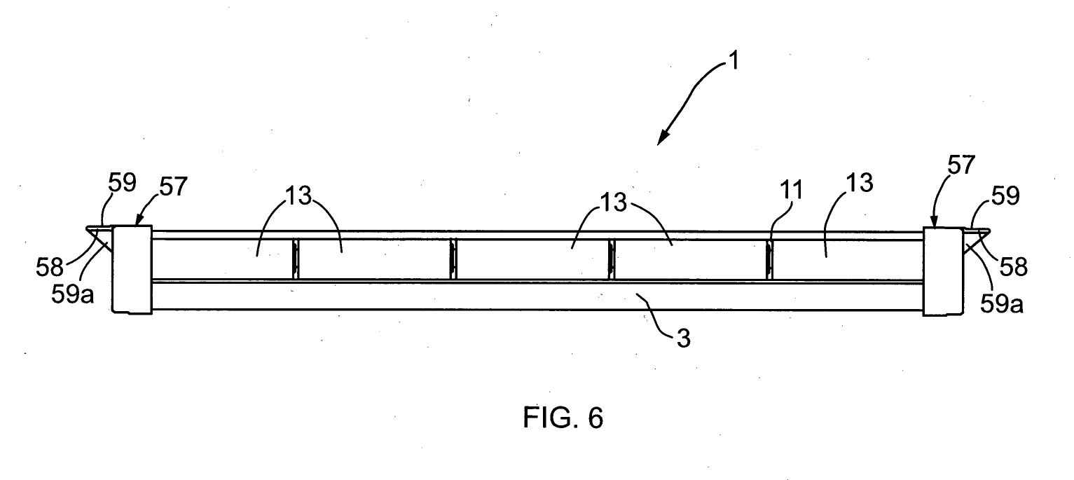

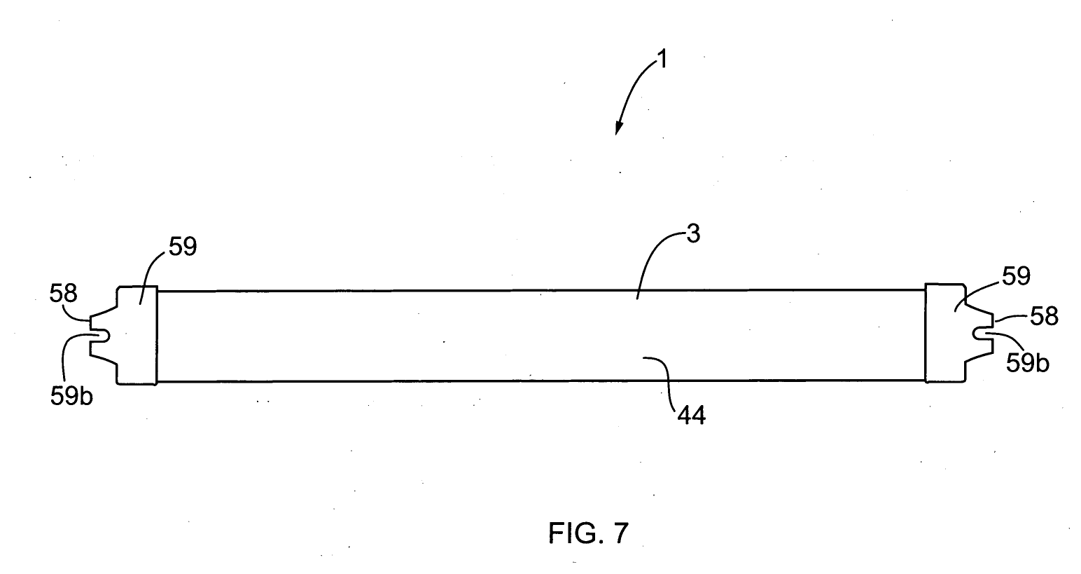

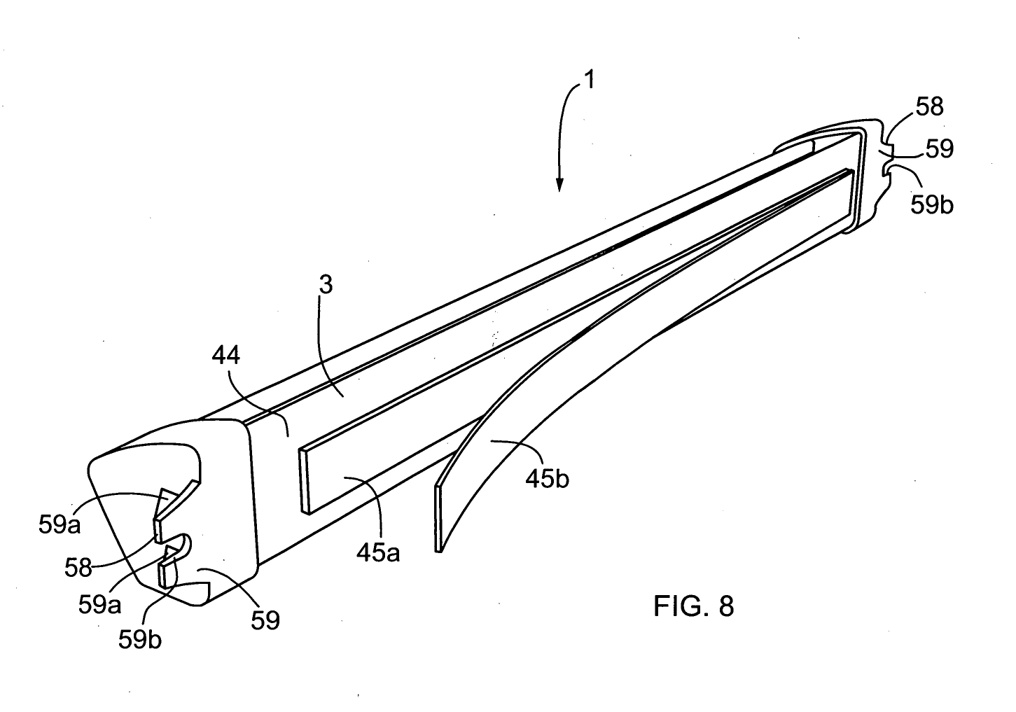

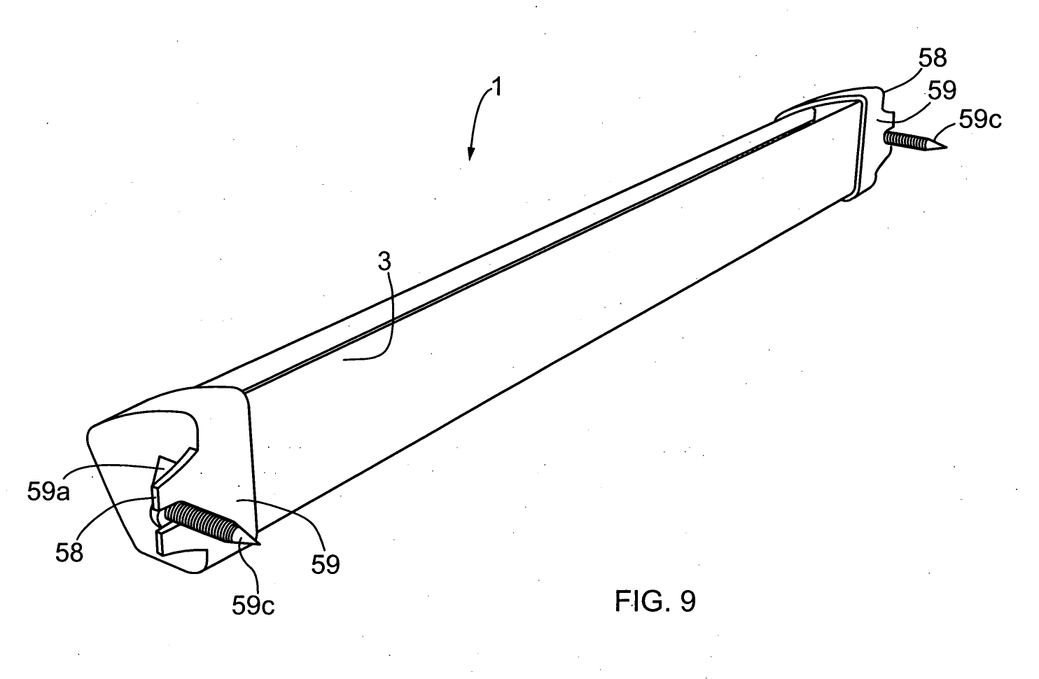

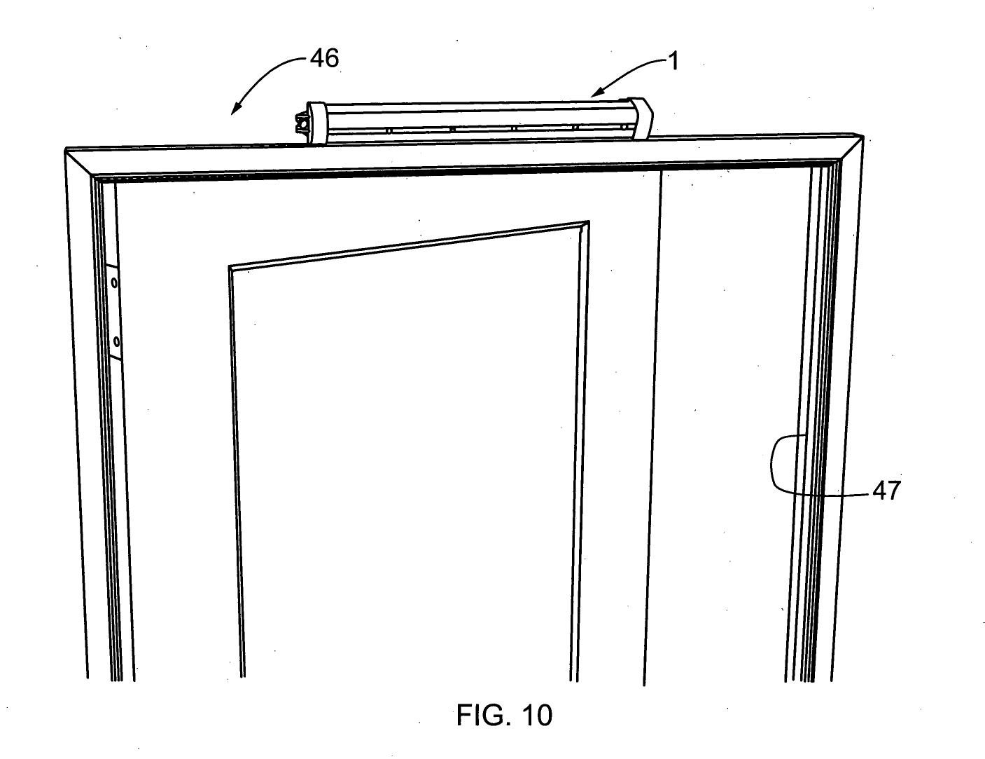

Referring to FIGS. 1 through 10, a lighting fixture 1 has a lighting mount 3, a linear strip lighting source 5, and electrical connections 7. The lighting mount 3 has an elongate body 4 with a longitudinal dimension L with a lighting source holder section 8 having an elongate linear cavity 9 for retaining the lighting source 5. The cavity 9 has an opening 10 for the lighting source 5 to emit light from the lighting mount 3 at a front face 6. The body 4 also has a battery holder section 11 for laterally retaining batteries 13. The cavity 9 and the battery holder section 11 each have a longitudinal dimension substantially parallel to the body longitudinal dimension L. In the example shown in the FIGS., the batteries 13 are cylindrical, and the batteries 13 are five AA dry cell batteries 13. Other sizes and quantities of batteries may be used as desired with consequent modification to the profile of the lighting mount 3. The cavity 9 is defined by a cavity wall 14 of the body 4. The lighting source has substantially parallel opposing first and second longitudinal edges 15, 16.

For ease of manufacture, the lighting mount 3 can be continuous along its longitudinal dimension. It can also have a uniform profile normal to the longitudinal dimension L for the length of the longitudinal dimension L as shown. In some cases it may be desired to have different profiles normal to the longitudinal dimension L along the length of the longitudinal dimension L. The lighting mount 3 can be a single piece of material, for example, a plastic such as ABS (acrylonitrile butadiene styrene) or PVC (polyvinyl chloride). A continuous and single piece of material lends itself to efficient manufacture, for example, by way of extrusion. A lighting mount additionally having a uniform profile along the length of the longitudinal dimension L provides for simple extrusion.

The lighting source 5 has an elongate substrate 17 that holds a plurality of light-emitting diodes (LEDs) 19 to form a light strip lighting source 5. The substrate 17 may be a printed circuit board. Other light strip substrates 17 may be used, such as a flexible light strip substrate. The LEDs 19 can be, for example, LTL915 series LEDs sold by LITE-ON Technology Corporation of Taiwan, Republic of China. The opening 10 extends from a first end 21 of the lighting mount 3 to an opposing second end 23 of the lighting mount 3. The cavity 9 has a track 25 across the opening 10 made up of two opposing grooves 27, 29 on either side of the opening 10 to retain laterally the elongate substrate 17 at the edges 15, 16. One side 30 of each groove 27, 29 extends fully across the substrate 17 to the LEDs 19 to provide a pleasing appearance. The sides 30 are angled where they meet the LEDs 19 so as not to block light from the LEDs 19.

The battery holder 11 has a U-shaped channel wall 30a, defining a U-shaped channel 31 extending from the first end 21 to the second end 23. The opposing first edge 33 and second edge 35 extend from the first end 21 to the second end 23. Bosses 37, 39 extend into the channel 31 from the first and second edges 33, 35, respectively. The channel edges 33, 35 are preferably above a centreline 41 of cylindrical batteries 13 to allow the bosses 37, 39 to retain the batteries 13. The interior of the channel wall 30a has a round profile below the battery centreline 41 to match the profile of the batteries 13. This provides a bottom 42a to the U-shaped channel 31 that conforms to an arcuate surface 42 of the cylindrical batteries 13. The channel wall 30a has a longitudinal aperture 42b at the top of the U-shaped channel 31. The channel wall 30a is resiliently flexible to allow the batteries 13 to be inserted into channel 31 through the aperture 42b over the bosses 37, 39 and to be laterally retained by the channel wall 30a.

The channel 31 could have other profiles to accommodate alternative battery 13 shapes, such as a square profile for square batteries 13.

The cavity wall 14 has a first wall portion 47 extending from the first edge 33 about a portion of the cavity 9 to a first side 48 of the opening 10. A second wall portion 49 extends from outside the channel 31 between the first edge 33 and second edge 35 about another portion of the cavity 9 to an opposing second side 51 of the opening 10. A third wall portion 52 between the first and second wall portions 47, 49 is a portion of the body 4 shared with the channel wall 30a. The third wall portion 52 and, thus, the cavity wall 14 are contiguous with the channel wall 31. The lighting source 5 can be slidably inserted along the edges 15, 16 into the track 25 from an end of the lighting mount 3. The first wall portion 47 and second wall portion 49 contain the grooves 27, 29 and retain the lighting source 5.

Alternatively, the first wall 47 and second wall 49 could be made sufficiently resiliently flexible to allow the light strip to be inserted into the grooves 27, 29 from in front. Other alternative embodiments are also possible to allow the lighting source 5 to be inserted into the cavity 9, retained between a substantially enclosed front face 6 of the cavity wall 14 and resilient tabs, or other retaining devices through a longitudinal aperture in the cavity wall 14 with cavity 9 otherwise substantially enclosed by the cavity wall 14 with a series of openings, each opening for a respective one of the LEDs to emit light from the cavity 9. Additional openings could be provided as required for user-accessible features, such as switch 62 (see description below). This can provide a more aesthetically pleasing appearance and additional protection for the lighting source 5.

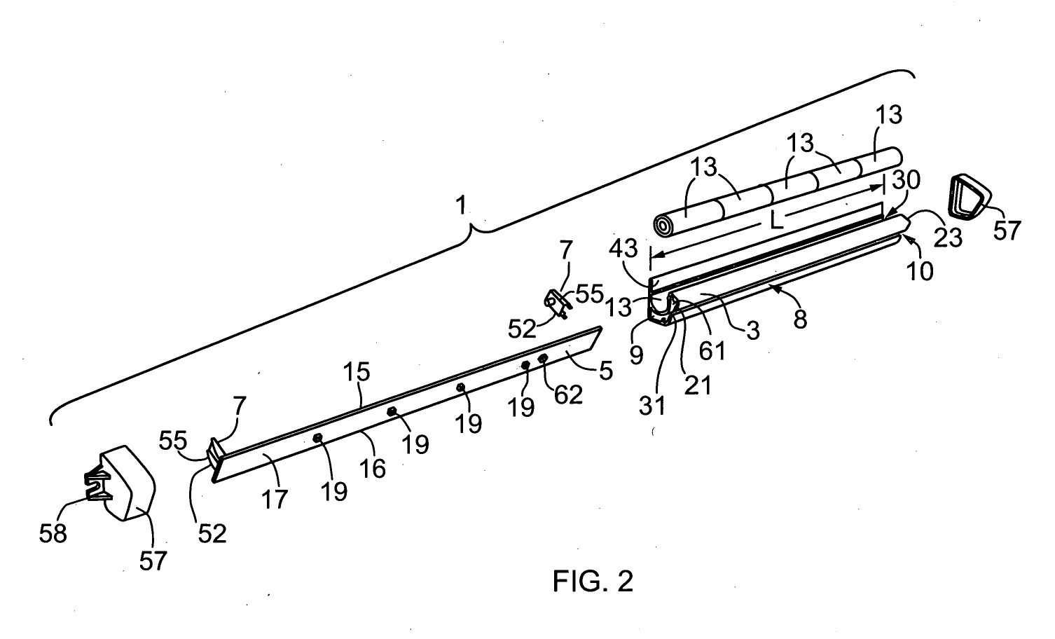

Electrical connections 52 extend from the lighting source 5 to the battery holder 11. In the embodiment shown the electrical connections 52 are provided by conductive stand-off contacts 55 fixed to the substrate 17, by soldering or otherwise, and extend to either end of the battery holder 11 about the ends 21, 23 to engage the batteries 13. The conductive stand-off contacts 55 have sufficient strength to longitudinally retain the batteries 13 in the channel 31. As shown in FIG. 2 one of the contacts 55 may be affixed to the substrate 17 prior to assembly of the lighting fixture 1; while the other contact 55 can be affixed after the substrate 17 is inserted in the lighting mount 3. This permits passage of the substrate 17 through the track 25 during insertion. Many alternative electrical connections 52 between the battery holder 11 and the lighting source 5 may be provided. Similarly, other orders of assembly may be used. Some alternatives are discussed herein by way of example and not as a limitation. As an example, the electrical connections 52 may be a pair of wires, not shown, extending from the lighting source 5 about either end 21, 23 of the lighting mount 3 to contacts 55 for the batteries 13.

Caps 57 are provided to enclose the ends 21, 23 of the lighting mount 3. As a further alternative, the electrical connections 52 may be mounted in the caps 57, with end caps 57 longitudinally retaining the batteries 13 in the channel 31. The caps 57 hide internal components and provide an aesthetically pleasing finish.

Alternatively, the wires could extend through a hole, not shown, in the channel 31 to the battery holder section 11. As a further alternative, lighting source 5 can be provided with contacts to which conductors in the caps 57 could attach. Many other forms of electrical connections 52 will be evident to those skilled in the art.

The channel wall 30a could encircle the channel 31. If so, the batteries 13 could be inserted through an end of the channel 31 when an end cap 57 is removed. The contact at that end would also be removable, for example, with end cap 57.

The caps 57 have flanges 58 extending outwardly longitudinally. Each flange 58 provides a mounting surface 59 for lighting fixture 1, for example, to a wall or other surface. To allow mounting of the lighting fixture 1 from the mounting surface 59, the battery holder section 11 and cavity 9 are on one side of the mounting surface 59. The battery holder section 11 is between the cavity 9 and the mounting surface 59, 45. The mounting surface 59 is planar. The flanges have angled support struts 59a for bracing. The flanges 58 have openings 59b through which screws 59c or the like may be used to secure the mounting of lighting fixture 1. Alternatively or in addition, double-sided tape, not shown, can be used for adhesion. Additional or extended flanges, not shown, can provide mounting surfaces with other orientations. For example, flanges extending outwardly in the same direction as the flanges 58, but at a right angle thereto, can allow the lighting fixture 1 to be mounted on a ceiling. Other configurations of mounting surfaces and adhesion methods will be evident to those skilled in the art.

The lighting mount 3 may be used such that the lighting mount 3 can be mounted directly using tab 43 that extends linearly away from the channel edge 35. The mounting tab 43 provides a mounting surface 44. Double-sided tape 45a with a peel away covering 45b can be placed on the mounting surface 44 for adhesion. Alternatively or in addition, screws or the like, not shown, through the mounting tab 43 can be used to affix the lighting mount 3.

The track 25 is at, and thus the lighting source 5 is retained at, an oblique angle to the mounting surfaces 59, 45 and the LEDs 19 have a beam angle A such that a light from the LEDs 19 includes a quadrant with one edge parallel to the mounting surface 59, 45 and one edge directed perpendicularly away from the mounting surface 59, 45. This allows the lighting fixture 1 to be mounted, for example, in a closet 46 above a doorway 47 to illuminate the interior space facing the doorway 47. If the LEDs 19 have a beam angle A greater than the size of the quadrant (90°), then one edge of the beam angle A can be aligned parallel to the mounting surface 59, 45, for example, to allow more light to shine upwardly in a closet application to illuminate upper shelves or reflect off of a ceiling. The beam angle A may be, for example, 120° as shown in the FIGS.

If the pattern of the LEDs 19 is circular then four LEDs 19 spaced at 4-inch intervals on an 18-inch long lighting mount 3 have been found suitable above a 30-inch closet doorway. Multiple lighting fixtures 1, or lighting fixtures 1 of different sizes, can be used for wider or small openings 10. More or fewer LEDs 19 placed at lesser or greater spacing may be used.

Preferably, light from the LEDs 19 will overlap to provide more even lighting. The beam angle A can have a centreline C directed at approximately 120° to the mounting surface 15 as shown in the FIGS. Other relative alignments of the LEDs 19 and mounting surface 59, 45 may be used as desired.

The cavity wall 14 and channel wall 31 could be formed separately, for example by way of extrusion, and fused, for example by heat welding to create body 4.

The body 4 could be created by other processes including, for example, injection molding. Injection molding can allow creation of more intricate body 4 shapes. For example, end caps could be integrated into the body 4 to enclose ends of the lighting mount 3 during molding (see discussion of non-integrated external end caps 57 below). If the end caps are integrated then access to the interior of the lighting source holder section 8 and the battery holder section 11 can be provided, for example, by molding the body 4 in two longitudinal halves through the lighting source holder section 8 and the battery holder section 11. The halves can be releasably secured to each other, for example, by screws or the like, for repeated access to the lighting source, or permanently secured, for example, by heat welding. Electrical connections 52 can be provided between the battery holder section 11 and the lighting source holder section 8 through conduits accessible when the halves are separate. The front face 6 could be enclosed substantially by the cavity wall 14 with a series of openings 10, each opening 10 for a respective one of the LEDs 19 to emit light from the cavity 9. Additional apertures could be provided as required for user-accessible features, such as switch 62 (see description below). This can provide a more aesthetically pleasing appearance and additional protection for the lighting source 5.

Where two body halves are used, it may be preferable to have the channel wall 30a surround, encircle for cylindrical batteries 13, the channel 31. The batteries 13 could be inserted into the channel 30 when the halves are separate. Alternatively, a separate removable door, not shown, could be provided to the channel 31 for insertion of the batteries 13.

As the lighting fixture 1 is battery powered, no external wiring is necessary; although, such wiring may be provided if desired for a particular application, for example, to provide in-circuit battery recharging.

The lighting fixture 1 may include a control 60 for activation and deactivation of the lighting source 5, such as automated operation through a light sensor or timer. The control 60 can be mounted on the lighting source 5 on a printed circuit board of elongate substrate 17. The cavity 9 protrudes away from the opening 10 to form a pocket 61 between the track 25 and the cavity wall 14. The control 60 can be mounted at least in part on the elongate substrate 17 facing into the pocket 61 toward the second wall 49 to hide and protect the control 60.

An example of such a control 60 and a lighting appliance incorporating such a control 60 is the control and lighting appliance described in U.S. patent application Ser. No. 11/523,093 filed 19 Sep. 2006 under title Lighting Controls And Lighting Appliances Incorporating Lighting Controls, by at least one of the applicants hereof. The content of the co-pending US patent application is hereby incorporated by reference into the detailed description hereof.

It is to be recognized that many different configurations of the lighting fixture 1 are possible. For example, cavity 9 could extend from underneath channel 31 with a mounting surface 59, 45 extending from the channel 31 to the cavity 9. Consequent modifications to the profile of the cavity 9 would be required. The cavity 9 and battery holder section 11 would continue to be on one side of the mounting surface 59, 45. The opening 10 could be directed away from the channel 31 and/or the mounting surface 59, 45 for, for example, under-shelf mounting. The battery holder section 11 would no longer be between the cavity 9 and the mounting surface 59, 45.

If desired, the control 60 could be provided with a user input device 62 for providing user input to the control 60. For example, the control 60 could include a switch 62 with a push button 64 for manually powering the lighting source 5 on and off. The switch 62 can be mounted on the elongate substrate 17 facing toward the opening 10 such that push button 64 of the switch 62 is accessible to a user. The control 60 may include a voltage regulator, controller, light sensor, switches (external to the lighting fixture 1, for example on the face of the lighting source 5) and other circuitry, not shown, to provide and control power from the batteries 13 to the lighting source 5. It is also recognized that various embodiments have been described herein having a variety of function features. Some features have been described only with respect to some embodiments; however, it is possible to apply features from one embodiment to another within the spirit and scope of the invention as defined by the following claims.

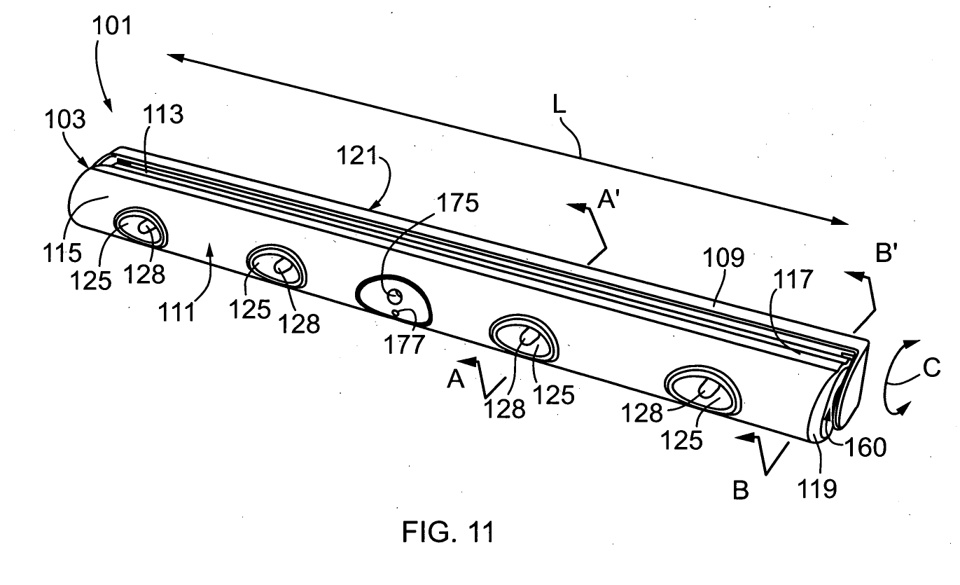

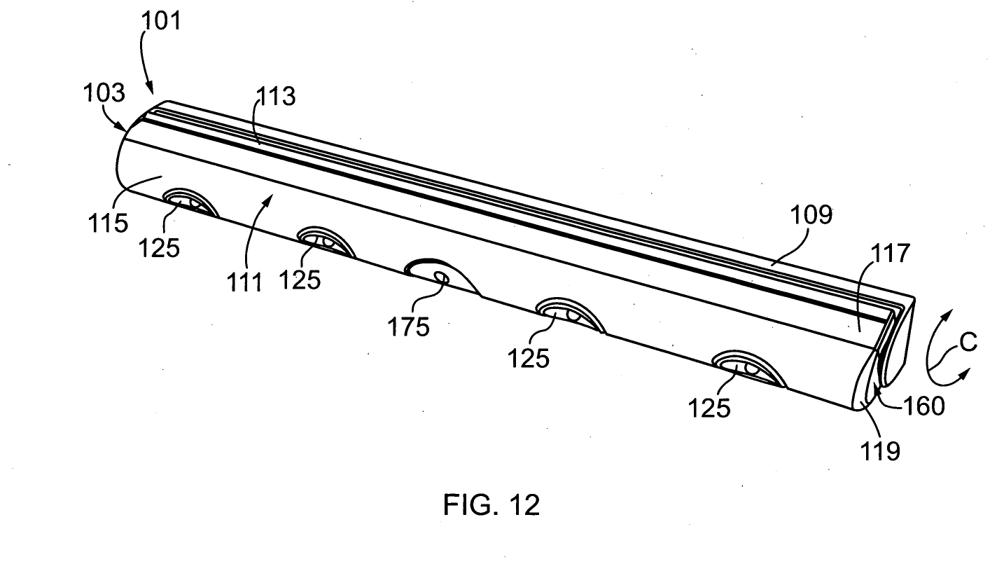

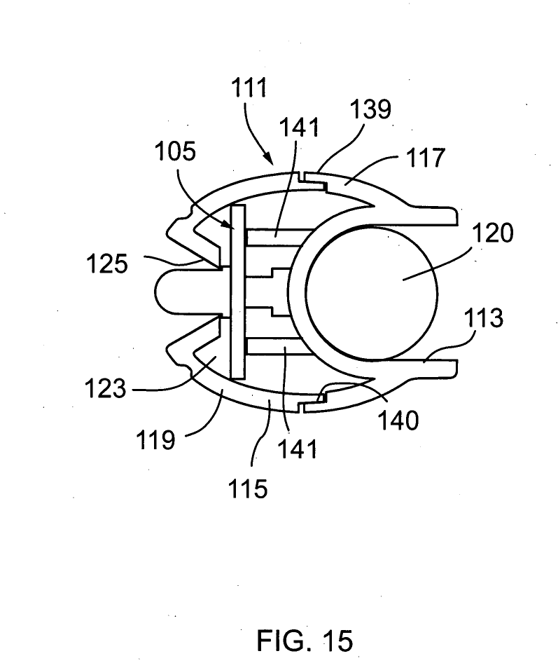

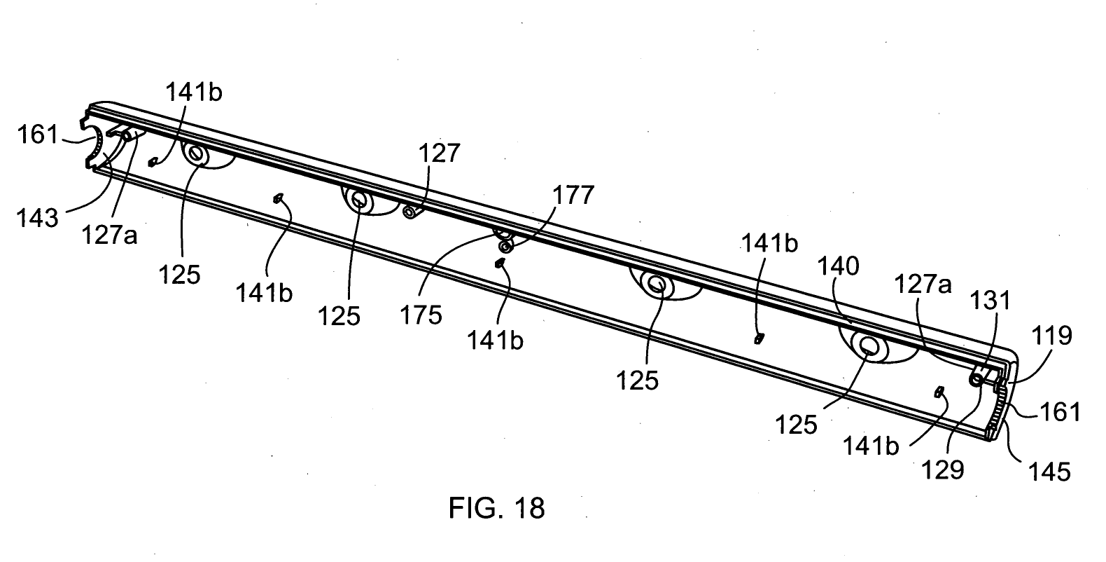

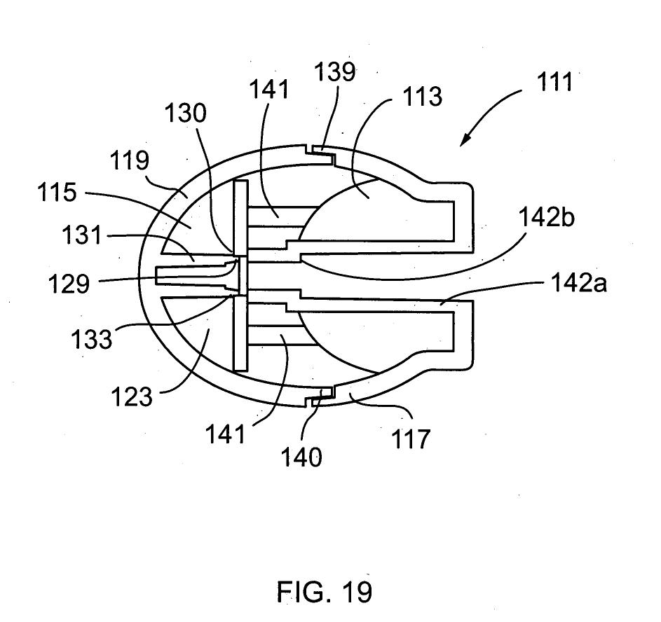

Referring to FIGS. 11 through 19, lighting fixture 101 has a lighting mount (indicated generally as 103), a lighting source 105, and electrical connections 107. The lighting mount 103 has a mounting base 109 and an elongate body 111. Elongate body 111 has an elongate battery holder section 113 and an elongate lighting source holder section 115. The lighting holder section has two portions 117, 119. Portion 117 is integral with battery holder section 113.

The elongate body 111 has a longitudinal dimension L. The battery holder section 113 and the lighting source holder section 115 each have a longitudinal dimension substantially parallel to the body longitudinal dimension L. The battery holder section 113 and the lighting source holder section 115 are contiguous with one another along their respective longitudinal dimensions. Although the sections 113, 115 are contiguous with one another along their respective longitudinal dimensions, this does not require the sections 113, 115 to be of the same length. The battery holder section 113 as shown in the FIGS, is shorter than the lighting source holder section 115; however, to the extent the section 113 has a longitudinal dimension that dimension is contiguous with the lighting source holder section longitudinal dimension.

The battery holder section 113 retains batteries 120 laterally and longitudinally. Again, in the example shown in FIGS. 11-19, the batteries 120 are cylindrical and the batteries are four AA dry cell batteries 120. Other sizes and quantities of batteries 120 may be used as desired with consequent modification to the profile and length of the battery holder section 113. For example, one battery 120 could be used provided it has sufficient appropriate electrical specifications to power the components of the light fixture 101.

The mounting base 109 has a mounting surface 121. The mounting surface 121 is planar. The battery holder section 113 and lighting holder section 115 are on one side of the mounting surface 121.

While lighting mount 3 is particularly well adapted to extrusion moulding, lighting mount 103 is well adapted to injection moulding. Other techniques manufacturing techniques may be utilized. Similar materials may be utilized.

The lighting source 105 is similar to lighting source 5. Except as expressly set out herein the description of lighting source 5 applies to lighting source 105. Like components from lighting source 5 will be provided with similar reference numerals.

The lighting source holder section 115 has an elongate cavity 123 defined by the lighting source holder section portions 117, 119. A series of openings 125 are provided at a front face 126 of the elongate body 111 through cavity wall 127 of lighting source holder section portion 119 to the cavity 123. The openings 125 are spaced to align with the LEDs 19. More or fewer openings 125 of equal or different spacing could be used as desired with consequent modification to the lighting source 105. The openings are angled so as not to block light emitting from the LEDs 19, while limiting exposure of the lighting source 105 outside the cavity 123. This serves to provide additional protection to the lighting source 105. It may also provide improved aesthetics. If desired the openings could be covered by a protective lens, not shown, to provide additional protection.

The LEDs 19 may be replaced by standard through-hole LEDs 128 such that the LEDs 128 can project into the openings 125 as shown in the FIGS. Alternatively, LEDs 19 may sit behind the openings 125 such that light from the LEDs projects into and through the openings 125. In either case the openings 125 light from the LEDs 19, 128 projects away from the mounting surface 121 and the battery holder section 113.

The lighting source holder section portion 119 has a series of retaining posts 127. Retaining posts 127a at either end of the lighting source holder section 119 have an initial smaller dimension 129 then a greater dimension 131 providing a stop surface 133. The lighting source 105 has corresponding apertures 130 of greater dimension than the smaller dimension 129 and lesser dimensions than the greater dimension 131 such that the lighting source 105 can be placed over the posts 127a against the stop surface 133 to align the lighting source 105 with respect to the openings 125. When separate the portions 117, 119 allow access to the cavity 123 for insertion and fixing of the lighting source 105.

A flange 139 extends about an external edge of portion 117, while a corresponding flange 140 extends about an internal edge of portion 119. The flange 140 fits snugly with the flange 139 to align the portions 117, 119. Additional support pins 141a are provided to support the lighting source 105 in the lighting source holder section portion 117. The support pins 141a are spaced apart laterally as well as longitudinally. Tabs 141b extend from the portion 119 to assist in locating and supporting the lighting source 105.

Support posts 142a extend from the lighting source holder section portion 117 across the cavity 123. The posts 142a align with the posts 127. The posts 142a are hollow with an internal seat 142b to receive screws, not shown, until a head of the screw is seated against the internal seat 142b. The posts 127 are internally threaded to receive the screw from the posts 142a such that the portions 117, 119 can be secured to one another. The posts 142a also support the lighting source 105 when the portions 117, 119 are combined.

Other techniques of securing the portions 117, 119 are possible, including for example heat welding the posts 142a, 127 or spots about the exterior of the portions 117, 119. This method of securing the portions 117, 119 is generally considered to be permanent as separation of the portions 117, 119 would likely result in breakage of some aspects of the mount 103. As a further example, the lighting source holder section portion 119 may extend past the lighting source holder section portion 117 and the battery holder section 113 to allow securing at a rear of the elongate body 111 that would typically be out of view when the light fixture 101 is in use. The lighting source holder section portions 117, 119 could be snap-fitted to one another.

Each portion 117, 119 has a pivot aperture part 143, 144, 145, 146 which when the portions 117, 119 are combined forms a pair of opposing pivot apertures 148 (only one of which is evident in the FIGS.). The mounting base 109 has a pair of opposing flanges 149, 151 extending away from the mounting surface 121 from either end 153, 155 of base plate 157. Extending away from the flanges 149, 151 are opposing respective pivot pins 158, 159. The pivot pins 153, 155 are aligned to one another and are aligned substantially parallel to the longitudinal dimension of the elongate body 111. The pivot pins 158, 159 correspond to the pivot apertures 148 such that insertion of the pivot pins 158, 159 in the pivot apertures 148 results in a pivot connection (indicated generally as 160 once in the FIGS. for connection of pivot pin 158 and pivot aperture 148) between the elongate body 111 and the mounting base 109.

As shown in the FIGS., the pivot pins 158, 159 are a tubular portion of a circular arc greater than half the circumference of a full circle. This is done for moulding purposes. It is of course possible to provide for full circle tubular or cylindrical pins 158, 159.

The pivot connection 160 permits pivoting of the elongate body 111 with respect to the mounting base 109 and indicated by arrow C, and thus the battery holder section 113 and lighting source holder section 115 with respect to the mounting surface 121. The elongate body 111 can be pivoted such that the battery holder section 113 is accessible for removal and insertion of batteries 120. The elongate body 111 can be pivoted to permit selection of a desired relative alignment between the mounting surface 121 and the LEDs 19.

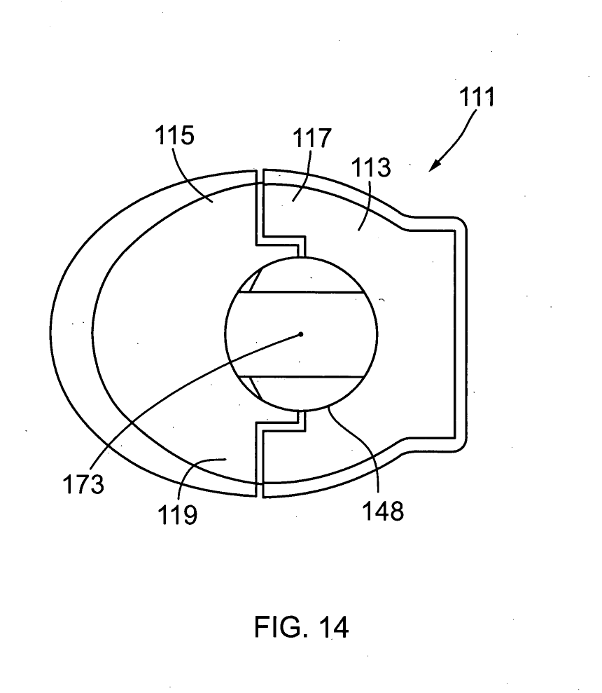

The pivotal connection 160 is provided with facets 161 (not shown in FIG. 14) inside the pivot apertures 148 and outside the pivot pins 158, 159. Engagement of the facets 161 provides a positive indication of a selected angle between the mounting base 109 and the elongate body 111. Other techniques for providing positive indication of a selected angle between the mounting base 109 and the elongate body 111 can be used.

The mounting base 109 can be resiliently flexible such that the flanges 149, 151 can be spread away from one another to along insertion or release of the pivot pins 158, 159 from the pivot apertures 148. Mounting openings 162, 163 are provided in the mounting base 109 to allow for the use of screws, not shown, to attach the mounting base 109 to a wall or other surface. Where screws are utilized, the mounting base 109 is first attached to the wall or other surface. The elongate body 111 is then snapped into place to make the pivotal connection 160. Preferably the batteries 120 are inserted prior to making the pivotal connection 160; however, the batteries 120 can be inserted afterward by pivoting the elongate body 111 to expose the battery holder section 113.

Alternatively, the elongate body 111 can be removed from the mounting base 109, the batteries 120 inserted, and the elongate body 111 attached to the mounting base 109 by making the pivotal connection 160. It is to be recognized that other connections between the mounting base 109 and the elongate body 111 are possible to provide the functionality or individual aspects thereof described herein. For example, the mounting base 109 could be flexibly attached to the elongate body to permit resilient flexing such that the battery holder section 113 would be accessible. Such a configuration may not permit pivotal selection of the angle between the mounting surface 121 and the LEDs 19.

The mounting base 109 could be attached to a surface using keyhole slots in place of the mounting openings 162, 163. Such keyhole slots could allow easier installation and removal of the mounting base 109. As discussed previously for other embodiments, openings 162, 163 could be placed on an extension of the mounting base 109 beyond the elongate body 111 to allow easy access. As a further example of other configurations, adhesive could be used to attach the lighting mount 103 to a wall or other surface. As discussed for other embodiments, the adhesive could be in the form of a double sided tape attached to the mounting base 109.

As illustrated herein the mounting base 109 is an integral unit. A mounting base could be provided in alternate forms. As an example, a mounting base could be a pair of opposable mounting angles, not shown. Each angle could have a planar surface forming part of the planar mounting surface, a mounting flange extending away from the mounting surface, and a pivot pin extending away from the flange. The mounting angles could be opposable such that the respective pivot pins are aligned with one another and aligned substantially parallel to the respective longitudinal dimensions of the lighting source holder section and the battery holder section.

The lighting fixture 101 could be provided as a kit with the elongate body 111 provided separate from the mounting base 109 for later installation of the mounting base 109 and connection of the elongate body 111 to the mounting base 109 as described elsewhere herein.

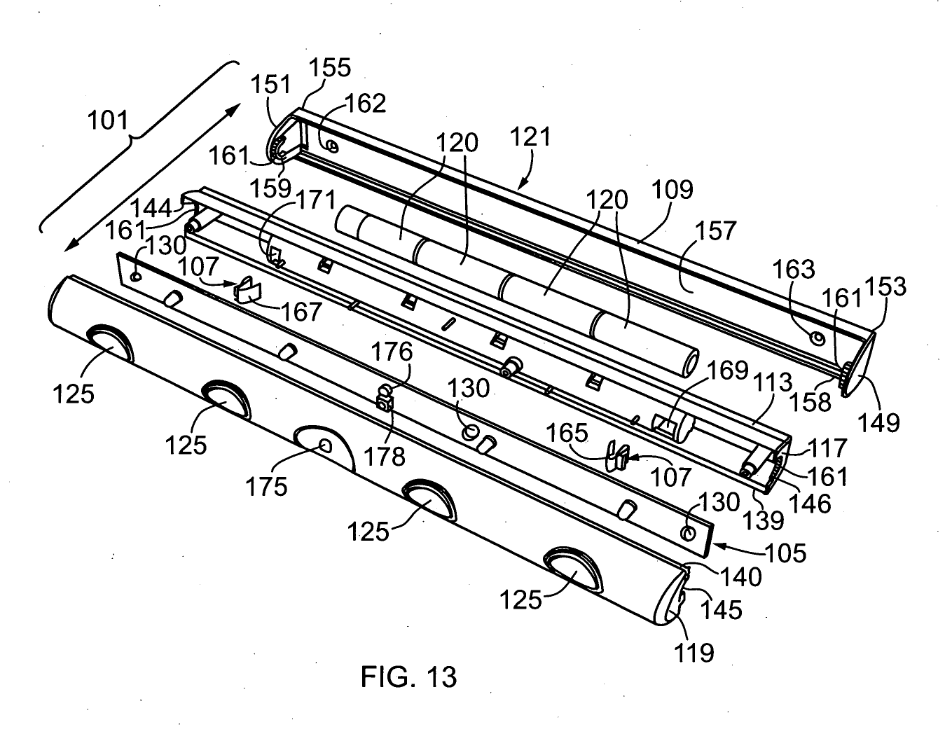

Battery holder section 113 has opposing contacts 165, 167 (see FIG. 13 only) to provide electrical connections for the lighting source 105 to the batteries 113. The contacts 165, 167 are connected to the lighting source 105 through openings 169, 171 between the battery holder section 113 and the lighting source holder section 115. Openings 169, 171 are provided oversize to allow for the contacts 165, 167 to be connected to the lighting source 105 before the portions 117, 119 are secured to one another as described below. The contacts are drawn through the openings 169, 171 and inserted over retaining end walls 172a. The contacts 165,167 may be connected to the lighting source 105 using wires, not shown, and solder or the like. Other forms of connection between the batteries 120 and the lighting source 105 may be used, including for example a direct connection of the contacts to the lighting source 105 with the openings inside the end walls 172a for support.

Although strip lighting sources 105 are convenient for use with the lighting fixture 101, other lighting sources may be used, including individual LEDs 19 wired to other components of the light fixture 101 as required. Individual LEDs 19 could be secured for example by epoxy or other fastening means in the openings 125 with wiring through cavity 123 to the batter holder section 113. The cavity 123 may be consequently reconfigured as desired.

The pivot apertures 148 have a centre (represented by dot 173) near a centre of the battery holder section 113 representing the location of a battery 120 longitudinal centreline, while favouring the lighting source holder section 115. This provides a balance about the pivot connection 160 such that neither the batteries 120 nor the lighting source 105 tend to cause the elongate body 111 to pivot after the elongate body 111 is set at a desired angle with respect to the mounting base 109. The resiliency of the mounting base and a close fit at the pivotal connection 160 plus facets 161 can also provide some friction between the mounting base 109 and the elongate body 111 to tend to prevent inadvertent pivoting of the elongate body 111 with respect to the mounting base 109.

An opening 175 in the front face 126 through the cavity wall 127 to the cavity 123 is provided for a light sensor 176 (such as the light sensor mentioned previously) forming part of the lighting source 105 to operate the lighting source 105. A further opening 177 is provided for a switch 178 (such as the switch mentioned previously) forming part of the lighting source 105 to operate the lighting source 105.

The opening 177 is small to receive a pin or other thin instrument for pressing the switch. Such a small opening 177 could be used where the switch 178 is not intended to be activated very often, for example where the switch 178 activates a reset of a control circuit. A larger opening 177 could be utilized for a switch that is to be manually operated.

Although the light sensor 176 and switch 178 are shown on the printed circuit board of the lighting source, the light sensor 176 and switch 178 could be provided separately from the printed circuit board for example on a separate printed circuit board, not shown.

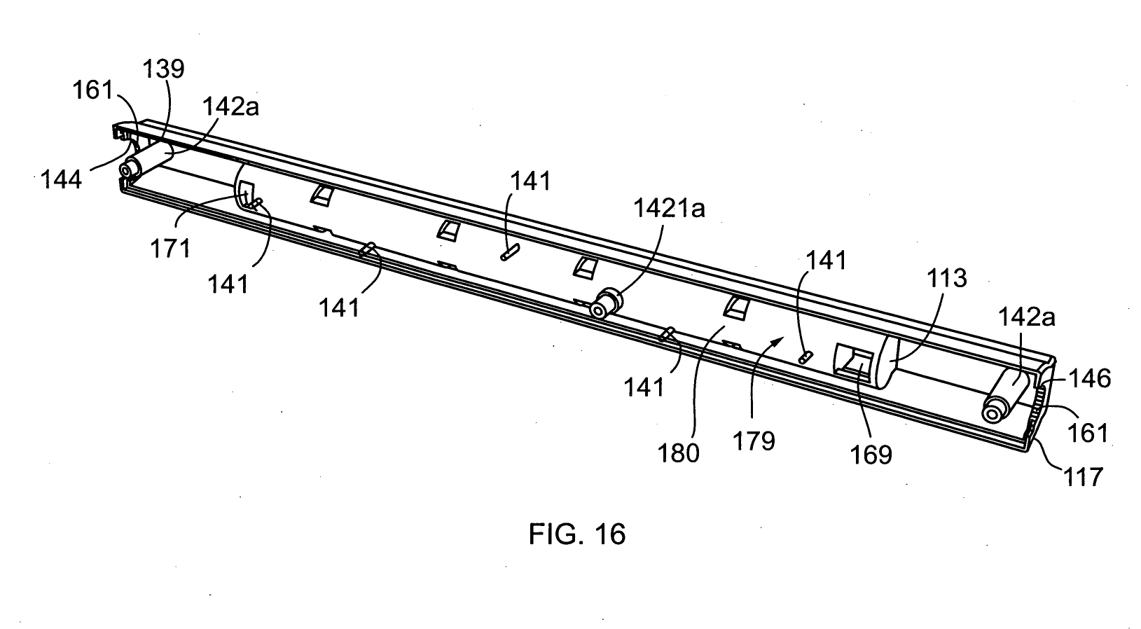

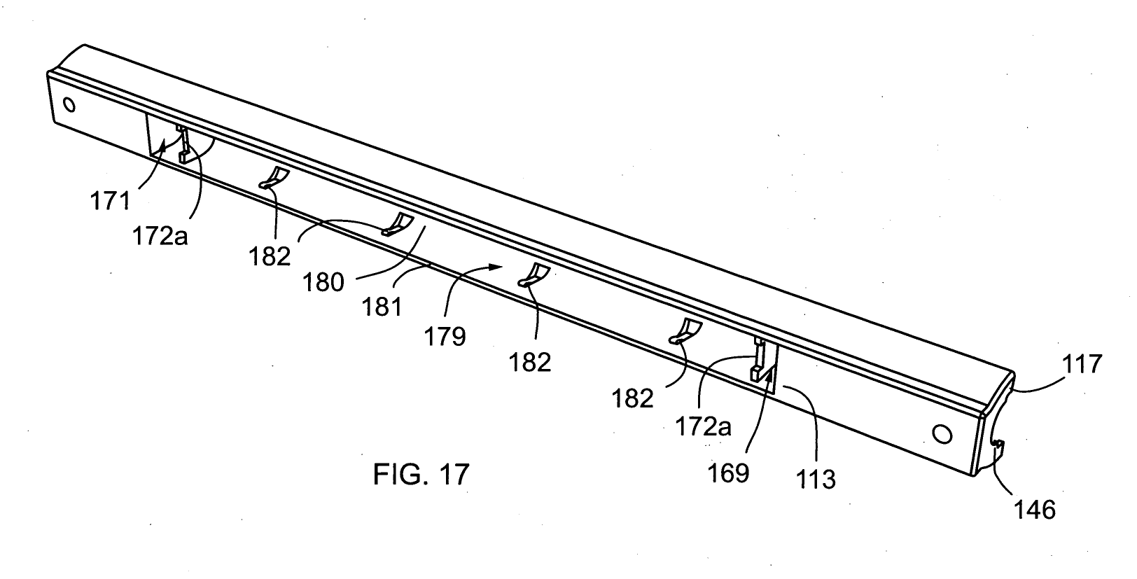

The battery holder section 113 has a channel 179 with a bottom 180 that conforms to a surface of the at least one battery, and a top 181 providing a longitudinal aperture to receive into the channel the at least one battery (see FIGS. 16, 17). In the FIGS. the batteries 120 are cylindrical and the bottom 180 has an arcuate surface. The channel 179 is similar to the channel 31. There is a series of opposing pairs of bosses 182, only one boss 182 from each pair is evident in the FIG. 17. The batteries 120 are snapped into the channel 179 over the bosses 182.

As a further example, it is possible to combine or exchange features of the example embodiments described herein. It will be understood by those skilled in the art that this description is made with reference to the example embodiments thereof and that it is possible to make other embodiments employing the principles of the invention which fall within its spirit and scope as defined by the following claims.

1. A lighting mount for use with at least one battery and a lighting source, the lighting mount comprising:
an elongate battery holder section having a longitudinal dimension, the battery holder section adapted to retain the at least one battery,
an elongate lighting source holder section having a longitudinal dimension, the lighting source holder section adapted to retain the lighting source, and
a planar mounting surface;
wherein the battery holder section includes a channel wall defining a lineal channel having a longitudinal dimension substantially parallel to the battery holder section longitudinal dimension, the channel wall adapted to retain laterally the at least one battery in the channel;
wherein the lighting source holder section includes an elongate cavity having a longitudinal dimension substantially parallel to the lighting source holder section longitudinal dimension;
wherein the battery holder section and lighting source holder section are contiguous with one another along their respective longitudinal dimensions;
wherein the cavity is defined at least in part by a cavity wall and the cavity wall has at least one cavity opening from the cavity; and
wherein the battery holder section and the lighting source holder section are on one side of the mounting surface, and the at least cavity opening opens away from the mounting surface and the battery holder section, and the at least one cavity opening opens such that light from the lighting source projects away from the mounting surface and the battery holder section.

2. The lighting mount of claim 1 further comprising a mounting base, wherein the mounting surface is part of the mounting base and the lighting holder source section is pivotally connected to the mounting base such that the openings can be pivoted to a desired angle with respect to the mounting surface.

3. The lighting mount of claim 1 wherein the battery holder section and the lighting source holder section together form an elongate body.

4. The lighting mount of claim 3 further comprising a mounting base, wherein the mounting surface is part of the mounting base and wherein the elongate body is pivotally connected to the mounting base such that the openings can be pivoted to a desired angle with respect to the mounting surface.

5. The lighting mount of claim 4 wherein the elongate body can be pivoted such that the channel is accessible for manual insertion of batteries into the channel.

6. The lighting mount of claim 4 wherein the mounting base comprises a pair of opposable mounting angles, each angle having a planar surface forming part of the planar mounting surface, a mounting flange extending away from the mounting surface, and a pivot pin extending away from the flange, the mounting angles being opposable such that the respective pivot pins are aligned with one another and aligned substantially parallel to the respective longitudinal dimensions of the lighting source holder section and the battery holder section.

7. The lighting mount of claim 4 wherein the lighting source holder section is adapted to retain the at least one lighting source such that an illumination axis of the lighting source is directed at an oblique angle away from the mounting surface.

8. The lighting mount of claim 4 wherein the lighting source holder section comprises two opposing longitudinally divided lighting source holder portions such that the cavity is accessible when the lighting source holder portions are separate from one another.

9. The lighting mount of claim 4 wherein the mounting base is an integral unit comprising the mounting surface, two opposing flanges extending away from the mounting surface, and a pair of pivot pins, one pivot pin extending away from each flange toward the other pivot pin such that the pivot pins are aligned with one another.

10. The lighting mount of claim 9 wherein the lighting source holder section comprises opposing pivot apertures at either end of the lighting source holder section to receive the pivot pins.

11. The lighting mount of claim 10 wherein the lighting source holder section comprises two opposing longitudinally divided lighting source holder portions such that the cavity is accessible when the lighting source holder portions are separate from one another, and each lighting source holder section defines a portion of the opposing pivot apertures such that the pivot apertures are wholly defined when the lighting source holder portions are combined.

12. The lighting mount of claim 10 wherein the mounting base is resiliently flexible to permit expansion of the mounting base and snap fitting of the pivot pins into the pivot apertures.

13. The lighting mount of claim 4 wherein the lighting source holder section is adapted to retain the at least one lighting source such that an illumination axis of the lighting source is directed at an oblique angle away from the mounting surface.

14. A lighting fixture comprising:
the lighting mount of claim 1;
the lighting source; and
electrical connections from the battery holder section to the lighting source.

15. The lighting fixture of claim 14 wherein the lighting source comprises a plurality of LEDs.

16. The lighting fixture of claim 15 wherein the lighting source further comprises an elongate substrate along which the LEDs are linearly spaced.

17. The lighting fixture of claim 16 wherein the elongate substrate is an elongate printed circuit board.

18. The lighting source of claim 17 wherein the lighting source is a strip lighting source.

19. The lighting fixture of claim 17 wherein the LEDs are surface mount LEDs.

20. The lighting fixture of claim 17 wherein the LEDs are standard through-hole LEDs.

21. The lighting fixture of claim 14 wherein the lighting source comprises at least one LED.

22. A kit comprising:
the lighting mount of claim 4;
the lighting source; and
electrical connections from the battery holder section to the lighting source,
wherein the mounting base is separate from and connectable to the elongate body.

23. A lighting mount for use with at least one battery and a lighting source, the lighting source being a strip lighting source with substantially parallel opposing first and second longitudinal edges, the lighting mount comprising:
an elongate body having a longitudinal dimension, the body including:
a battery holder section adapted to hold the at least one battery, and
a lighting source holder section adapted to hold the light source;
wherein the battery holder section includes a channel wall defining a lineal channel having a longitudinal dimension substantially parallel to the body longitudinal dimension, the channel wall adapted to retain laterally the at least one battery in the channel;
wherein the lighting source holder section includes a cavity wall defining an elongate lineal cavity having a longitudinal dimension substantially parallel to the body longitudinal dimension, the cavity wall adapted to retain laterally the lighting source in the cavity,
wherein the battery holder section and lighting source holder section are contiguous with one another along the longitudinal dimension of the body;
wherein the cavity wall has at least one cavity opening from the cavity through which light from the light source can project; and
wherein the at least one cavity opening opens such that light from the lighting source projects from the cavity away from the battery holder section.

24-36. (canceled)

37. A lighting fixture comprising:
the lighting mount of claim 21;
the lighting source; and
electrical connections from the battery holder to the lighting source.

38-42. (canceled)
